(19) United States
(12) Patent Application Publication
(10) Pub. No.: US 2012/0113181 A1
(43) Pub. Date: May 10, 2012

(54) Resist ink printing device

(75) Inventors: Ji Han Kwon, Suwon (KR); Ju Hwan Yang, Suwon (KR); Jun Young Kim, Suwon (KR); Ha Yoon Song, Hwaseong (KR); Jae Hun Kim, Seoul (KR); Hee Jin Park, Suwon (KR); Young Seuck Yoo, Seoul (KR); Sung Nam Cho, Buyeo-gun (KR)

(73) Assignee: SAMSUNG ELECTRO-MECHANICS CO., LTD., Suwon (KR)

(21) Appl. No.: 13/317,853

(22) Filed: Oct. 31, 2011

(30) Foreign Application Priority Data
Nov. 4, 2010 (KR) 10-2010-0109310

(51) Int. Cl. B41J 29/38

(52) U.S. Cl. 347/16

(57) ABSTRACT

There is provided a resist ink printing device according to an exemplary embodiment of the present invention including: a transfer unit transferring a substrate on which lead-in wires for electrolytic gold plating are patterned into a main body; a controller formed on the main body to measure a warpage degree of the substrate and recognizing a gerber file stored with circuit diagram information of the substrate to compensate for the warpage degree of the substrate and correct the gerber file; and at least one inkjet printing head part discharging liquid photo resist ink to the lead-in wires by the corrected gerber file.

### CROSS-REFERENCE TO RELATED APPLICATIONS

This application claims the priority of Korean Patent Application No. 10-2010-0109310 filed on Nov. 4, 2010, in the Korean Intellectual Property Office, the disclosure of which is incorporated herein by reference.

### BACKGROUND OF THE INVENTION

1. Field of the Invention

The present invention relates to a resist ink printing device, and more particularly, to a resist ink printing device capable of selectively discharging resist ink to lead-in wires for gold plating on a substrate.

2. Description of the Related Art

A gold plating process on a substrate is essentially performed in order to lower contact resistance with chips, or the like, mounted on the substrate, thereby improving the electrical characteristics thereof.

However, the gold plating process is performed by connecting plating lead-in wires made of copper to a portion to be plated with gold and after the gold plating process is completed, the plating lead-in wires should be removed in order to prevent the occurrence of noise.

In order to remove the plating lead-in wires, the pattern printing of liquid photo resist (LPR) ink should be essentially performed. In the related art, the substrate is coated by using a screen printing method.

That is, in the related art, the entire substrate is coated with the liquid photo resist (LPR) ink and dried for removing solvents serving as impurities.

In this case, there is a limitation in that productivity is degraded due to a lead time consumed to increase and reduce temperature within a drier.

In addition, exposure and developing processes are performed after the drying, in the related art. During the exposure process, photomask films for exposure fitting to each substrate are needed.

In this case, a plurality of films are needed to correct the warpage of the substrate due to a distortion phenomenon caused by the substrate. In addition, a process of checking the warpage of the substrate is essentially performed.

Therefore, production costs are increased due to the plurality of photomask films and productivity is degraded due to the process of checking for the warpage of the substrate, or the like.

On the other hand, the developing process needs a large amount of developer and a considerable amount of water for cleaning the developer, such that the time required for the process is increased.

Therefore, research to improve productivity by shortening the production costs and the process time required for production is urgently needed upon performing pattern printing on the liquid photo resist (LPR) ink in order to remove the lead wire for gold plating on the substrate.

### SUMMARY OF THE INVENTION

An aspect of the present invention provides a resist ink printing device capable of minimizing the usage of ink and improving productivity by introducing an inkjet process into a process of removing lead-in wires for gold plating on a substrate to perform pattern printing on liquid photo resist ink for removing the lead-in wires for gold plating on a substrate.

According to an aspect of the present invention, there is provided a resist ink printing device, including: a transfer unit transferring a substrate on which lead-in wires for electrolytic gold plating are patterned into a main body; a controller formed on the main body to measure a warpage degree of the substrate and recognizing a gerber file stored with circuit diagram information of the substrate to compensate for the warpage degree of the substrate and correct the gerber file; and at least one inkjet printing head part discharging liquid photo resist ink to the lead-in wires by the corrected gerber file.

The inkjet printing head part may selectively discharge the liquid photo resist ink to a top surface of the lead-in wires.

The resist ink printing device may further include a pseudo-hardening unit disposed at a rear side of the inkjet printing head part to harden the liquid photo resist ink discharged to the substrate.

The resist ink printing device may further include a head alignment checking unit included in the main body to measure deviations of the inkjet printing head part in order to align the inkjet printing head part.

The resist ink printing device may further include a substrate alignment checking unit included in the main body to measure the deviations of the substrate in order to align the substrate transferred into the main body.

The resist ink printing device may further include a cleaner unit included in the main body to clean the inkjet printing head part.

The inkjet printing head part may include a plurality of inkjet printing head parts, and the plurality of inkjet printing head parts are individually aligned.

The resist ink printing device may further include an unloading part moving the substrate to which the liquid photo resist ink is discharged to the outside of the main body. The resist ink printing device may further include a discharge evaluation unit included in the main body to check a droplet and uniformity of the discharged ink.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a resist ink printing device according to an exemplary embodiment of the present invention;

FIG. 2 is a diagram schematically showing a process in which a pseudo-hardening unit of a resist ink printing device irradiates ultraviolet rays to liquid photo resist ink discharged to a substrate according to an exemplary embodiment of the present invention;

FIG. 3 is a flow chart showing a process of a resist ink printing device according to an exemplary embodiment of the present invention; and

FIGS. 4A and 4B are photographs showing results of printing the liquid photo resist ink on the substrate by a resist ink printing device according to an exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, and those are to be construed as being included in the spirit of the present invention.

Further, throughout the drawings, the same or similar reference numerals will be used to designate the same components or like components having the same functions in the scope of the similar idea.

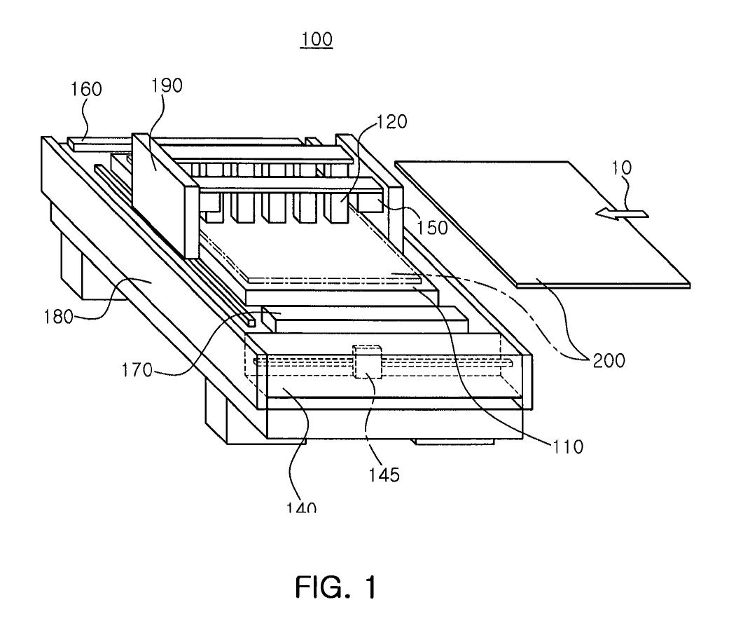

FIG. 1 is a perspective view schematically showing a resist ink printing device according to an exemplary embodiment of the present invention.

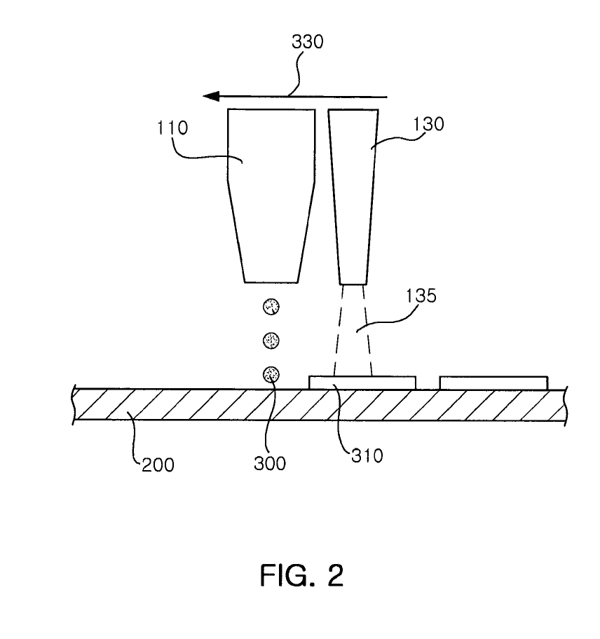

Referring to FIG. 1, a resist ink printing device 100 according to an exemplary embodiment may be configured to include a transfer unit 110, a controller (not shown), an inkjet printing head part 120, a pseudo-hardening unit 130 (see FIG. 2), a head alignment checking unit 10, a substrate alignment checking unit 150, a cleaner unit 160, an unloading part (not shown), and a discharge evaluation unit 170.

The transfer unit 110 may transfer a substrate 200 subjected to be processed immediately before a gold plating plasma process into a main body 180 of the resist ink printing device 100 according to an exemplary embodiment of the present invention.

In this case, the gold plating plasma process actually performs the gold plating in order to lower contact resistance with chips, or the like, mounted on the substrate 200, thereby improving electrical characteristics. The resist ink printing device 100 according to an exemplary embodiment of the present invention may be a device for selectively applying the liquid photo resist ink 300 (see FIG. 2) to remove the lead-in wires for gold plating to the substrate 200 before the gold plating plasma process.

The transfer unit 110 aligns the substrate 200 disposed on the outside of the main body 180 at the bottom portion of the inkjet printing head part 120 to be described below so as to apply the liquid photo resist ink 300 for gold plating thereto, but the transfer direction thereof is not limited.

That is, FIG. 1 shows that the substrate 200 moves in a right direction 10 in the resist ink printing device 100 according to an exemplary embodiment of the present invention, but the exemplary embodiment of the present invention is not limited thereto. As a result, the substrate may move in any direction.

In addition, the transfer unit 110 contacts a portion of the substrate 200 to move within the main body 180 and the transfer unit 110 may be coupled with a moving member such as a rail, etc., to move within the main body 180.

In this case, the lead-in wires for electrolytic gold plating on the substrate 200 moving by the transfer unit 110 may be patterned in order to selectively apply the liquid photo resist ink 300 by the inkjet printing head part 120.

In addition, if the substrate 200 moves into the main body 180 by the transfer unit 110, the deviations of the substrate 200 is measured by the substrate alignment checking unit 150 to align the substrate 200.

The controller (not shown) corrects a gerber file in order to selectively apply the liquid photo resist ink 300 to the substrate 200 and transfers the corrected gerber file to an encoder of the inkjet printing head part 100, thereby printing the liquid photo resist ink 300 on the substrate using compensation values.

In other words, the controller (not shown) measures the warpage degree of the substrate 200 and recognizes the gerber file stored with information about the circuit diagram of the substrate 200, when the substrate 200 on which the lead-in wires for electrolytic gold plating are patterned is located at the bottom portion of inkjet printing head part 120.

In other words, the controller (not shown) recognizes the pattern of the substrate 200 disposed at the bottom portion of the inkjet printing head part 120 by using a charge coupled device (CCD) camera, or the like, to determine the alignment and the warpage degree of the substrate 200 and compensate for the warpage degree of the substrate 200 and transfer it to a program.

In this case, the controller (not shown) corrects the gerber filer stored with the circuit diagram information of the substrate 20 by using the compensation value for the warpage degree of the substrate 200.

Through the process, the gerber file performs the conversion work of increasing or reducing images according to the warpage degree of the substrate 200.

When the conversion work is performed as described above, the controller transfers the corrected gerber file to the encoder of the inkjet printing head part 120 to recognize the liquid photo resist ink 300 through the compensation value, thereby making it possible to discharge and print the ink 300.

In this case, the controller (not shown) may be disposed at any locations within the main body 180 of the resist ink printing device according to an exemplary embodiment of the present invention. Preferably, the controller may be disposed at a location in which the controller is not viewed from the outside.

The inkjet printing head part 120 has a structure for discharging the liquid photo resist ink 300 to the lead-in wires for electrolytic gold plating patterned on the substrate 200 by the corrected gerber file and may be configured to include an inkjet head and a buffer tank.

In this case, the inkjet head substantially has a structure for discharging the liquid photo resist ink 300 to the lead-in wires formed on the substrate 200 through a nozzle and the buffer tank may have a structure capable of containing the liquid photo resist ink 300.

In other words, the inkjet printing head part 120 including the inkjet head and the buffer tank may be functionally operated as a single module and a plurality of inkjet printing head parts may be formed according to the size and area of the substrate 200.

In addition, the inkjet printing head part 120 may selectively discharge the liquid photo resist ink 300 on the top surface of the lead-in wires formed on the substrate 200 and may minimize and optimize the used amount of liquid photo resist ink 300 due to the selective discharge.

In the resist ink printing device 100 according to an exemplary embodiment of the present invention, the inkjet printing head part 120 may be fixed by a gantry part 190 and gantry part 190 is movably designed vertically and horizontally, such that the inkjet printing head part 120 may move simultaneously.

The gantry pat 190 may include a rail, or the like, to be vertically and horizontally moved and the inkjet printing heat part 120 may move together with the gantry part 190 or may move through a servo motor within the gantry part 190.

In this case, the inkjet printing head part 120 may be formed in plural and each inkjet printing head part 120 includes a separate controller to be optimally aligned.

In this case, the alignment of each inkjet printing head part 120 may be performed by the head alignment checking unit 140 to be described below, which will be described below.

The resist ink printing device 100 according to an exemplary embodiment may be configured to include the transfer unit 110, the controller (not shown), the inkjet printing head part 120, the pseudo-hardening unit 130, the head alignment checking unit 10, the substrate alignment checking unit 150, the cleaner unit 160, the unloading part (not shown), and the discharge evaluation unit 170.

The pseudo-hardening unit 130 is disposed at the back side of the inkjet printing head part 120 to harden the liquid photo resist ink 300 discharged to the substrate 200, which will be described in detail with reference to FIG. 2.

The head alignment checking unit 140 measures the deviations of the inkjet printing head parts 120 as described above to individually align the inkjet printing head parts 120.

The head alignment checking part 140 may be disposed on the front surface of the resist ink printing device 100 according to the exemplary embodiment of the present invention and includes a camera unit 145 movably disposed therein to measure the deviations between the heads of the inkjet printing head parts 120.

However, the head alignment checking unit 140 disposed at the front surface of the resist ink printing device 100 is by way of only and may be disposed at one side of the main body 180 in addition to the front surface thereof.

In addition, if a camera unit 145 configuring the head alignment checking unit 140 is an image pick-up camera capable of measuring the deviations, any image pick-up camera may be used without limitation and the number thereof is not limited.

The head alignment checking unit 140 measures the deviations between heads as described above and aligns the inkjet printing head parts, thereby making it possible to selectively discharge the liquid photo resist ink 300 to the lead-in wires for more stably electrolytic gold plating and more stably form the liquid photo resist ink pattern 310 (see FIG. 2).

The substrate alignment checking unit 150 checks whether the substrate is accurately disposed at the bottom portion of the inkjet printing head part 120 when the substrate moves into the main body 180 by the above-mentioned transfer unit 110 to measure the deviations of the substrate 200.

The substrate alignment checking unit 150 is coupled with the gantry part 190 to be horizontally moved, such that it can measure the deviations of the substrate 200 while moving.

The substrate alignment checking unit 150 may include the camera unit, if the camera unit is an image pick-up camera capable of measuring the deviations, any camera unit may be used without limitation and the number thereof is not limited.

Further, the substrate alignment checking unit 150 may be disposed in the gantry unit 190 of the resist ink printing device 100 according to an exemplary embodiment of the present invention and may be disposed at one side of the main body 180.

The cleaner unit 160 may perform cleaning using a cleaning robot when the inkjet printing head part 120 is polluted and may be disposed on the back surface of the resist ink printing device 100 according to an exemplary embodiment of the present invention.

The cleaner unit 160 may include a cleaning solution pan that can treat the cleaning solution cleaning the inkjet printing head part 120 and the cleaner unit 160 may be adjacently formed to the above-mentioned head alignment checking unit 140.

The unload unit (not shown) is a member that is included in the main body 180 to transfer the substrate 200, on which the lead-in wires for electrolytic gold plating is selectively printed with the liquid photo resist ink 300, to the outside and may be identical with the above-mentioned transfer unit 110.

That is, the substrate 200 may be moved into the main body 180 by the transfer unit 110 and may move to the outside of the main body.

However, the unloading part (not shown), which is a member different from the transfer unit 110, may be provided separately

The discharge evaluation unit 170, which is a component that is included in the main body 180 to check the droplet and uniformity of the liquid photo resist ink 300 selectively discharged to the lead-in wires for electrolytic gold plating, may be disposed at the top end of the resist ink printing device 100 according to the exemplary embodiment of the present invention.

That is, the discharge evaluation unit 170 may measure and correct the amount and uniform extent of the liquid photo resist ink sprayed from the nozzle of the inkjet printing head part 120, thereby making it possible to more stably form the liquid photo resist ink pattern 300.

FIG. 2 is a diagram schematically showing a process which a pseudo-hardening unit of a resist ink printing device irradiates ultraviolet rays to liquid photo resist ink discharged to a substrate according to an exemplary embodiment of the present invention.

Referring to FIG. 2, the pseudo-hardening unit 130 is disposed at the back side of the inkjet printing head part 120 to irradiate ultraviolet rays 135 to a region 310 to which the liquid photo resist ink 300 is discharged.

That is, the lead-in wires for electrolytic gold plating is primarily and selectively applied with the liquid photo resist ink 300 by the inkjet printing head part 120 and the liquid photo resist ink 300 may be secondarily hardened by directly irradiating the ultraviolet rays 135 to the secondarily applied region 310.

In addition, the pseudo-hardening unit 130 may be adjacently formed to the inkjet printing head part 120 so that it can be operated in connection with the inkjet printing head part 120 and may be identical with the direction 330 in which the inkjet printing head part 120 moves, that is, the printing direction 330.

In this case, the liquid photo resist ink 300 is hardened by the pseudo-hardening unit 130 and the substrate 200 moving to the outside of the main body 180 by the unloading part (not shown) serves to fix the liquid photo resist ink pattern 310 to the substrate 200 before entering into the subsequent process, the drying process.

When the drying process is performed to remove solvents serving as impurities within the liquid photo resist ink 300, the liquid photo resist ink 300 may be completely hardened.

In other words, the liquid photo resist ink 300 is primarily hardened by the pseudo-hardening unit 130 and secondarily and completely hardened by the drying process.

However, it is to be noted that the drying process may be omitted according to a type of the liquid photo resist ink 300.

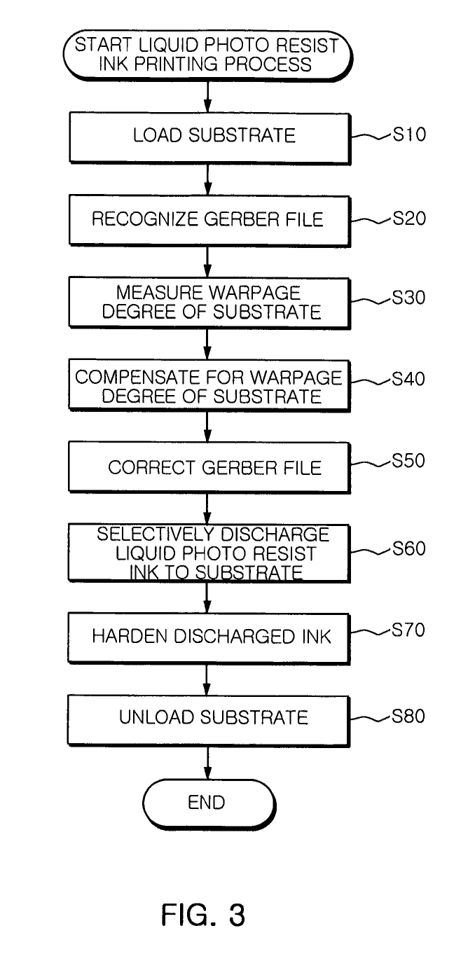

FIG. 3 is a flow chart showing a of a resist ink printing device according to an exemplary embodiment of the present invention.

Referring to FIG. 3, when the process of the resist ink printing device according to the exemplary embodiment of the present invention is started, the substrate 200 to be printed with the liquid photo resist ink by the transfer unit 110 is transferred into the main body 130.

In this case, the head alignment checking unit 140 is operated simultaneously or previously to measure the deviations of the inkjet printing head parts 120 and aligns the inkjet printing head parts 120, thereby making it possible to stably and selectively the liquid photo resist ink 300 to the lead-in wires for electrolytic gold plating.

In addition, if the substrate 200 moves into the main body 180 by the transfer unit 110, the deviations of the substrate 200 is measured by the substrate alignment checking unit 150 to align the substrate 200 at the bottom portion of the inkjet printing head part 120.

Thereafter, the controller (not shown) recognizes the gerber file stored with the circuit diagram information (S20) and measures the warpage degree of the substrate 200(S30).

In this case, the recognition of the gerber file (S20) and the measurement of the warpage degree of the substrate 200 (S30) may be performed simultaneously or reversely, independent of a sequence.

When the recognition of the gerber file (S20) and the measurement of the warpage degree (S30) are completed, the controller (not shown) compensates for the warpage degree of the substrate 200 and transfers it to the program.

In this case, the gerber file stored with the circuit diagram information of the substrate 200 is corrected through the compensation value and the gerber file performs the conversion work that increases or reduces images according to the warpage degree of the substrate 200.

When the conversion work is performed as described above, the controller transfers the corrected gerber file to the encoder of the inkjet printing head part 120 to recognize the position in which the liquid photo resist ink 300 is discharged through the compensation value, thereby making it possible to discharge and print the liquid photo resist ink 300 (S60).

Thereafter, the pseudo-hardening unit 130 disposed at the back side of the inkjet printing head part 120 is operated and the pseudo-hardening unit 130 may harden the ink by irradiating the ultraviolet rays to the region to which the liquid photo resist ink is discharged.

When the hardening is completed, a process of selectively patterning the liquid photo resist ink 300 to the lead-in wires for electrolytic gold plating is completed when the substrate 200 is unloaded in order to enter the drying process for complete hardening (S80).

Thereafter, the gold plating process is completed in order to improve the electrical characteristics of the substrate 200 that is subjected to the drying process for completely hardening the liquid photo resist ink 30, the gold plating plasma process, the gold plating process, the cleaning and drying process, the liquid photo resist peeling process, and the lead-in removing process for electrolytic gold plating.

However, the above-mentioned drying process may be omitted according to a type of the liquid photo resist ink 300.

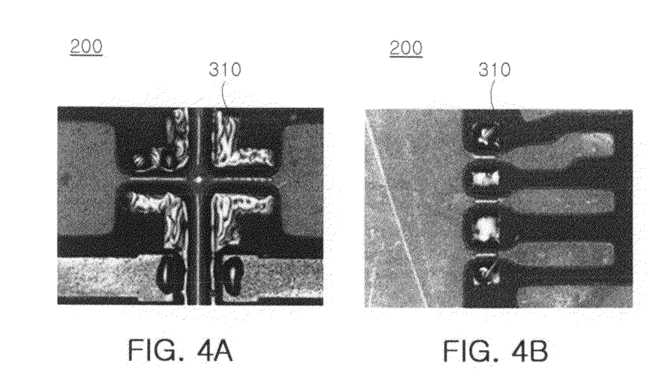

FIG. 4A and 4B are photographs showing results of printing the liquid photo resist ink on the substrate by the resist ink printing device according to the exemplary embodiment of the present invention.

FIG. 4A and 4B show shapes in which the liquid photo resist ink is patterned 310 on the copper wire of the substrate 200 and is applied only to the desired portion.

That is, the resist ink printing device 100 according to the exemplary embodiment of the present invention selectively patterns 310 the liquid photo resist ink 300 only at the desired portion by the inkjet printing method, thereby making it possible to remarkably reduce the exiting processes.

In other words, it does not need to perform the processes required in the related art to pattern the liquid photo resist ink 300 to the lead-in wires for electrolytic gold plating, that is, the process of printing the liquid photo resist ink on the entire substrate by the screen printing method, the exposure process photo-curing the necessary portions by aligning the printing films for exposure and the substrate 200 and irradiating ultraviolet rays, the developing process for removing the liquid photo resist ink 300 to which ultraviolet rays are not irradiated during the exposure process by using a developer, or the like.

In particular, although the related art requires several sheets of photomask films according to the warpage degree in order to correct the warpage phenomenon of the substrate 200 during the exposure process, the present invention corrects and aligns the warpage through the image conversion of the gerber file, so that the photomask films are not required. Therefore, the present invention may be referred to as a maskless process.

The above-mentioned exemplary embodiments of the present invention selectively performs the pattern 310 printing on the liquid photo resist ink 300 necessary for the lead-in wires removing process for electrolytic gold plating on the substrate 200 by using the inkjet printing head part 120, thereby making it possible to minimize and optimize the usage of the liquid photo resist ink 300.

In addition, the above-mentioned exemplary embodiments of the present invention does not use the photo masks while remarkably reducing the existing processes upon printing the liquid photo resist ink 300 to lower the production costs of the substrate 200 and shorten the production time, thereby making it possible to maximize the productivity.

As set forth above, the resist ink printing device according to the exemplary embodiment of the present invention can optimize the usage of the liquid photo resist ink during the process of removing the lead-in wires for gold plating by introducing the inkjet process.

In addition, the exemplary embodiment of the present invention can improve the process time, the production cost, and the productivity by correcting a gerber file stored with circuit diagram information of the substrate to apply the liquid photo resist ink to the substrate.

While the present invention has been shown and described in connection with the exemplary embodiments, it will be apparent to those skilled in the art that modifications and variations can be made without departing from the spirit and scope of the invention as defined by the appended claims.

What is claimed is:

1. A resist ink printing device, comprising:
a transfer unit transferring a substrate on which lead-in wires for electrolytic gold plating are patterned into a main body;
a controller formed on the main body to measure a warpage degree of the substrate and recognizing a gerber file stored with circuit diagram information of the substrate to compensate for the warpage degree of the substrate and correct the gerber file; and
at least one inkjet printing head part discharging liquid photo resist ink to the lead-in wires by the corrected gerber file.

2. The resist ink printing device of claim 1, wherein the inkjet printing head part selectively discharges the liquid photo resist ink to a top surface of the lead-in wires.

3. The resist ink printing device of claim 1, further comprising a pseudo-hardening unit disposed at a rear side of the inkjet printing head part to harden the liquid photo resist ink discharged to the substrate.

4. The resist ink printing device of claim 1, further comprising a head alignment checking unit included in the main body to measure deviations of the inkjet printing head part in order to align the inkjet printing head part.

5. The resist ink printing device of claim 1, further comprising a substrate alignment checking unit included in the main body to measure the deviations of the substrate in order to align the substrate transferred into the main body.

6. The resist ink printing device of claim 1, further comprising a cleaner unit included in the main body to clean the inkjet printing head part.

7. The resist ink printing device of claim 1, wherein the inkjet printing head part includes a plurality of inkjet printing head parts, and
the plurality of inkjet printing head parts are individually aligned.

8. The resist ink printing device of claim 1, further comprising an unloading part moving the substrate to which the liquid photo resist ink is discharged to the outside of the main body.

9. The resist ink printing device of claim 1, further comprising a discharge evaluation unit included in the main body to check a droplet and uniformity of the discharged ink.
